(19) United States
(12) Patent Application Publication
(10) Pub. No.: US 2020/0278684 A1
(43) Pub. Date: Sep. 3, 2020

(54) METHODS AND SYSTEMS FOR CONTROLLING LATERAL POSITION OF VEHICLE THROUGH INTERSECTION

(71) Applicant: GM GLOBAL TECHNOLOGY OPERATIONS LLC, Detroit, MI (US)

(72) Inventors: Mohammad Naserian, Windsor (CA); Donald K. Grimm, Utica, MI (US); Syed Ali, West Bloomfield, MI (US); Vivek Vijaya Kumar, Shelby Township, MI (US)

(73) Assignee: GM GLOBAL TECHNOLOGY OPERATIONS LLC, Detroit, MI (US)

(21) Appl. No.: 16/289,848

(22) Filed: Mar. 1, 2019

(51) Int. Cl. G05D 1/02; B60W 30/18; G05D 1/00

(52) U.S. Cl. CPC G05D 1/0221; B60W 10/18; G05D 1/0088; B60W 30/18154

(57) ABSTRACT

Systems and methods are provided for controlling a lateral position of a vehicle through an intersection. The method includes receiving, by a processor, intersection data transmitted by an infrastructure associated with the intersection, the intersection data including at least a position of a plurality of lanes associated with the intersection. The method includes receiving, by the processor, a position of the vehicle, and determining, by the processor, a current lane of travel of the vehicle and a future lane of travel of the vehicle based on the intersection data and the position of the vehicle. The method includes determining, by the processor, a virtual lane through the intersection, the virtual lane providing a path of travel for the vehicle from the current lane of travel to the future lane of travel. The method includes controlling, by the processor, the vehicle based on the virtual lane.

### INTRODUCTION

The technical field generally relates to methods and systems for controlling a vehicle, and more particularly relates to methods and systems for controlling a lateral position of a vehicle through an intersection.

Autonomous and semi-autonomous vehicles may rely on image data, such as that received from a camera, to control a lateral position of the vehicle relative to a lane of travel. Generally, the autonomous and semi-autonomous vehicle may rely on lane markings, identified based on the image data provided by the camera, for controlling the lateral position of the vehicle. In certain instances, one or more areas of a roadway, such as an intersection, may be devoid of lane markings. In other instances, the intersection may include lane markings that are not applicable to a current lane of the vehicle, for example, lane markings for making a turn from another lane of travel, which may interfere with the lateral control of the vehicle through the intersection.

Accordingly, it is desirable to provide improved methods and systems for controlling a lateral position of a vehicle through an intersection. Furthermore, other desirable features and characteristics of the present invention will become apparent from the subsequent detailed description and the appended claims, taken in conjunction with the accompanying drawings and the foregoing technical field and background.

### SUMMARY

According to various embodiments, provided is a method for controlling a lateral position of a vehicle through an intersection. The method includes receiving, by a processor, intersection data transmitted by an infrastructure associated with the intersection, the intersection data including at least a position of a plurality of lanes associated with the intersection. The method includes receiving, by the processor, a position of the vehicle, and determining, by the processor, a current lane of travel of the vehicle and a future lane of travel of the vehicle based on the intersection data and the position of the vehicle. The current lane of travel is spaced apart from the future lane of travel by the intersection. The method includes determining, by the processor, a virtual lane through the intersection, the virtual lane providing a path of travel for the vehicle from the current lane of travel to the future lane of travel. The method includes controlling, by the processor, the vehicle based on the virtual lane.

The controlling, by the processor, the vehicle based on the virtual lane includes outputting, by the processor, one or more control signals to a lateral control system of the vehicle to maintain the vehicle within the virtual lane. The controlling, by the processor, the vehicle based on the virtual lane further includes outputting, by the processor, one or more control signals to a human-machine interface to guide an operator of the vehicle through the intersection. The method further includes receiving, by the processor, a lane marking associated with the intersection identified by at least one camera associated with the vehicle; determining, by the processor, whether the lane marking associated with the intersection corresponds with the virtual lane; and controlling, by the processor, the vehicle based on the determining whether the lane marking associated with the intersection corresponds with the virtual lane. The controlling, by the processor, the vehicle based on the determining whether the lane marking associated with the intersection corresponds with the virtual lane further includes determining, by the processor, the lane marking associated with the intersection corresponds with the virtual lane, and outputting, by the processor, one or more control signals to a lateral control system to maintain the vehicle within the virtual lane. The controlling, by the processor, the vehicle based on the determining whether the lane marking associated with the intersection corresponds with the virtual lane further includes determining, by the processor, the lane marking associated with the intersection conflicts with the virtual lane; and outputting, by the processor, one or more control signals to a lateral control system to suppress lateral control based on the determining that the lane marking associated with the intersection conflicts with the virtual lane. The determining, by the processor, the current lane of travel of the vehicle and the future lane of travel of the vehicle further includes determining, by the processor, the current lane of the vehicle based on the position of the vehicle and the intersection data; receiving, by the processor, at least one of a heading of the vehicle, a rate of change of the heading of the vehicle and turn signal data associated with a turn signal lever of the vehicle; and determining, by the processor, the future lane of travel based on the at least one of the heading, the rate of change of the heading and the turn signal data, the current lane of travel and the intersection data. The determining, by the processor, the virtual lane through the intersection further includes determining, by the processor, a coordinate location of a first point on the current lane and a coordinate location of a second point on the future lane; calculating, by the processor, a distance between the coordinate location of the first point and the coordinate location of the second point; determining, by the processor, at least one intermediate point between the current lane and the future lane based on the distance; calculating, by the processor, a coordinate location for the at least one intermediate point based on the coordinate location of the first point or the second point and the distance; and extrapolating, by the processor, the virtual lane based on the coordinate location for the first point, the coordinate location for the second point and the coordinate location of the at least one intermediate point.

Further provided is a system for controlling a lateral position of a vehicle through an intersection with a lateral control system. The system includes a communication system having a receiver configured to receive intersection data including at least a position of a plurality of lanes associated with the intersection and a sensor system that provides a position of the vehicle and a lane marking associated with the intersection that is detected by a camera of the vehicle. The system includes a controller having a processor programmed to: determine a current lane of travel of the vehicle and a future lane of travel of the vehicle based on the intersection data and the position of the vehicle, the current lane of travel spaced apart from the future lane of travel by the intersection; determine a virtual lane through the intersection, the virtual lane providing a path of travel for the vehicle from the current lane of travel to the future lane of travel; compare the virtual lane to the lane marking; and output one or more control signals to the lateral control system based on the comparison.

The processor is programmed to output one or more control signals to a human-machine interface to guide an operator of the vehicle through the intersection. Based on the comparison of the virtual lane to the lane marking, the processor is further programmed to output one or more control signals to the lateral control system to maintain the vehicle within the virtual lane based on the virtual lane corresponding with the lane marking. Based on the comparison of the virtual lane to the lane marking, the processor is further programmed to output one or more control signals to the lateral control system to suppress lateral control based on the virtual lane conflicting with the lane marking. The processor is further programmed to determine the current lane of the vehicle based on the position of the vehicle and the intersection data, to receive at least one of a heading of the vehicle, a rate of change of the heading of the vehicle and turn signal data associated with a turn signal lever of the vehicle, and to determine the future lane of travel based on the at least one of the heading, the rate of change of the heading and the turn signal data, the current lane of travel and the intersection data. The processor is further programmed to determine a coordinate location of a first point on the current lane and a coordinate location of a second point on the future lane, to calculate a distance between the coordinate location of the first point and the coordinate location of the second point, to determine at least one intermediate point between the current lane and the future lane based on the distance, to calculate a coordinate location for the at least one intermediate point based on the coordinate location of the first point or the second point and the distance, and to extrapolate the virtual lane based on the coordinate location for the first point, the coordinate location for the second point and the coordinate location of the at least one intermediate point. The processor is further programmed to output one or more control signals to a lateral centering system associated with the vehicle based on the virtual lane.

Also provided is a vehicle. The vehicle includes a communication system onboard the vehicle having a receiver configured to receive intersection data including at least a position of a plurality of lanes associated with the intersection, and a sensor system onboard the vehicle that provides a position of the vehicle and a lane marking associated with the intersection that is detected by a camera of the vehicle. The vehicle includes an actuator system onboard the vehicle including a lateral control system that is configured to control a lateral position of the vehicle. The vehicle includes a controller having a processor programmed to: determine a current lane of travel of the vehicle and a future lane of travel of the vehicle based on the intersection data and the position of the vehicle, the current lane of travel spaced apart from the future lane of travel by the intersection; determine a virtual lane through the intersection, the virtual lane providing a path of travel for the vehicle from the current lane of travel to the future lane of travel; compare the virtual lane to the lane marking; output one or more control signals to the lateral control system of the vehicle to maintain the vehicle within the virtual lane based on the virtual lane corresponding with the lane marking; and output one or more control signals to the lateral control system to suppress lateral control based on the virtual lane conflicting with the lane marking.

The processor is further programmed to determine the current lane of the vehicle based on the position of the vehicle and the intersection data, to receive at least one of a heading of the vehicle, a rate of change of the heading and turn signal data associated with a turn signal lever of the vehicle, and to determine the future lane of travel based on the at least one of the heading, the rate of change of the heading and the turn signal data, the current lane of travel and the intersection data. The processor is further programmed to determine a coordinate location of a first point on the current lane and a coordinate location of a second point on the future lane, to calculate a distance between the coordinate location of the first point and the coordinate location of the second point, to determine at least one intermediate point between the current lane and the future lane based on the distance, to calculate a coordinate location for the at least one intermediate point based on the coordinate location of the first point or the second point and the distance, and to extrapolate the virtual lane based on the coordinate location for the first point, the coordinate location for the second point and the coordinate location of the at least one intermediate point. The processor is further programmed to output one or more control signals to a lateral centering system associated with the vehicle based on the virtual lane. The processor is programmed to output one or more control signals to a human-machine interface to guide an operator of the vehicle through the intersection.

### BRIEF DESCRIPTION OF THE DRAWINGS

The exemplary embodiments will hereinafter be described in conjunction with the following drawing figures, wherein like numerals denote like elements, and wherein:

FIG. 1 is an illustration of a vehicle having an intersection control system in accordance with various embodiments;

FIG. 2 is a dataflow diagram illustrating the intersection control system in accordance with various embodiments;

FIG. 3 is an example of a virtual lane determined by the intersection control system in which the determined virtual lane does not correspond or conflicts with a lane marking detected by a sensor system of the vehicle in accordance with various embodiments;

FIG. 4 is an example of a virtual lane determined by the intersection control system in which the determined virtual lane corresponds with the lane marking detected by the sensor system of the vehicle in accordance with various embodiments;

FIG. 5 is a flowchart illustrating a control method that can be performed by the intersection control system in accordance with various embodiments; and

FIG. 6 is a flowchart illustrating a method to determine a virtual lane that can be performed by the intersection control system in accordance with various embodiments.

### DETAILED DESCRIPTION

The following detailed description is merely exemplary in nature and is not intended to limit the application and uses. Furthermore, there is no intention to be bound by any expressed or implied theory presented in the preceding introduction, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

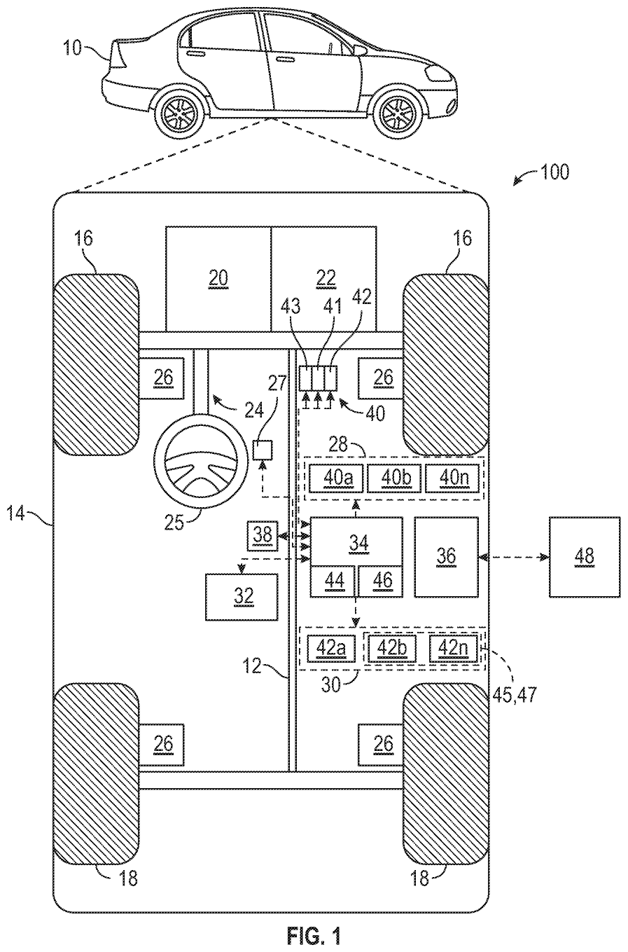

With reference to FIG. 1, an intersection control system shown generally as 100 is associated with a vehicle 10 in accordance with various embodiments. In general, the intersection control system (or simply “system”) 100 generates virtual lane data or a virtual lane through an intersection for use in controlling the vehicle 10. In various embodiments, the intersection control system 100 generates the virtual lane data based on information obtained from a positioning system of the vehicle 10, a sensor system of the vehicle 10 and/or from intersection data broadcast from an infrastructure (or other entity) associated with the intersection.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The vehicle wheels 16-18 are each rotationally coupled to the chassis 12 near a respective corner of the body 14.

In various embodiments, the vehicle 10 is an autonomous vehicle or a semi-autonomous vehicle. As can be appreciated, the intersection control system 100 can be implemented in other non-autonomous systems and is not limited to the present embodiments. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, etc., can also be used.

As shown, the vehicle 10 generally includes a propulsion system 20, a transmission system 22, a steering system 24, a brake system 26, a sensor system 28, an actuator system 30, at least one data storage device 32, at least one controller 34 and a communication system 36. The vehicle 10 may also include a navigation system 38 and a human-machine interface 40. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmission.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences a position of the vehicle wheels 16 and/or 18. While depicted as including a steering wheel 25 for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the vehicle 10. In various embodiments, the sensing devices 40a-40n include, but are not limited to, radars (e.g., long-range, medium-range-short range), lidars, global positioning systems, optical cameras (e.g., forward facing, 360-degree, rear-facing, side-facing, stereo, etc.), thermal (e.g., infrared) cameras, ultrasonic sensors, odometry sensors (e.g., encoders) and/or other sensors that might be utilized in connection with systems and methods in accordance with the present subject matter. The sensor system 28 provides information for determining a position of the vehicle 10 relative to an intersection, and provides information of lane markings detected by the sensor system 28, such as those observed by the optical cameras. The sensor system 28 also provides information regarding a position of the steering wheel 25, and in one example, the sensor system 28 also observes a position of the steering wheel 25 or steering wheel angle and provides the observed steering wheel angle to the controller 34. The sensor system 28 also provides information regarding a speed profile of the vehicle 10, and in one example, the sensor system 28 observes an acceleration or deceleration of the vehicle 10 and provides the observed acceleration or deceleration to the controller 34. The sensor system 28 also provides information regarding a yaw rate of the vehicle 10, and in one example, the sensor system 28 observes the yaw rate of the vehicle 10 and provides the observed yaw rate to the controller 34.

The actuator system 30 includes one or more actuator devices 42a-42n that control one or more vehicle features such as, but not limited to, the propulsion system 20, the transmission system 22, the steering system 24, and the brake system 26. In various embodiments, the vehicle 10 may also include interior and/or exterior vehicle features not illustrated in FIG. 1, such as various doors, a trunk, and cabin features such as air, music, lighting, touch-screen display components (such as those used in connection with the navigation system 38), active safety seat or haptic seat, and the like. In various embodiments, one or more of the actuator devices 42a-42n control the one or more vehicle features to maintain or keep the vehicle 10 within a lane of a roadway and act as a lateral control system 45 or lane keeping system. In various embodiments, the actuator devices 42a-42n control the one or more vehicle features to maintain the vehicle 10 centered within a lane of a roadway and act as a lane centering system 47.

The data storage device 32 stores data for use in automatically controlling the vehicle 10. In various embodiments, the data storage device 32 stores defined maps of the navigable environment. In various embodiments, the defined maps may be predefined by and obtained from a remote system via the communication system 36. For example, the defined maps may be assembled by the remote system and communicated to the vehicle 10 (wirelessly and/or in a wired manner) and stored in the data storage device 32. As can be appreciated, the data storage device 32 may be part of the controller 34, separate from the controller 34, or part of the controller 34 and part of a separate system.

The communication system 36 is configured to wirelessly communicate information to and from other entities 48, such as but not limited to, other vehicles (“V2V” communication), infrastructure (“V2I” communication), networks (“V2N” communication), pedestrian (“V2P” communication), remote transportation systems, and/or user devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards. In this example, the communication system 36 includes at least a receiver that receives an intersection message broadcast or transmitted by the other entities 48, which may be broadcast or transmitted substantially continuously by a transmitter coupled to an infrastructure associated with an intersection.

The navigation system 38 processes sensor data, from the sensor system 28, for example, along with other data to determine a position (e.g., a local position relative to a map, an exact position relative to lane of a road, vehicle heading, rate of change of the vehicle heading, velocity, etc.) of the vehicle 10 relative to the environment. The navigation system 38 may access the data storage device 32 to retrieve the defined maps and based on the global position of the vehicle 10, from the global positioning system of the sensor system 28, determine the exact position of the vehicle 10 relative to a road identified in the map, the vehicle heading and a rate of change of the vehicle heading.

The human-machine interface 40 is in communication with the controller 34 via a suitable communication medium, such as a bus. The human-machine interface 40 may be configured in a variety of ways. In some embodiments, the human-machine interface 40 may include various switches or levers, such as a turn signal lever 27, one or more buttons, a touchscreen interface 41 that may be overlaid on the display 42, a keyboard, an audible device 43, a microphone associated with a speech recognition system, or various other human-machine interface devices. The display 42 comprises any suitable technology for displaying information, including, but not limited to, a liquid crystal display (LCD), organic light emitting diode (OLED), plasma, or a cathode ray tube (CRT). In this example, the display 42 is an electronic display capable of graphically displaying one or more user interfaces under the control of the controller 34. Those skilled in the art may realize other techniques to implement the display 42 in the vehicle 10. The audible device 43 comprises any suitable device for generating sound to convey a message to an operator or occupant of the vehicle 10.

The controller 34 includes at least one processor 44 and a computer-readable storage device or media 46. The processor 44 may be any custom-made or commercially available processor, a central processing unit (CPU), a graphics processing unit (GPU), an application specific integrated circuit (ASIC) (e.g., a custom ASIC implementing a neural network), a field programmable gate array (FPGA), an auxiliary processor among several processors associated with the controller 34, a semiconductor-based microprocessor (in the form of a microchip or chip set), any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10. In various embodiments, controller 34 is configured to implement instructions of the intersection control system 100 as discussed in detail below.

In various embodiments, the instructions, when executed by the processor, receive and process position information of the vehicle 10 and intersection data broadcast from an infrastructure or other entity 48 to determine a virtual lane through an intersection. The instructions determine the virtual lane and control the vehicle 10 through the intersection based on the virtual lane.

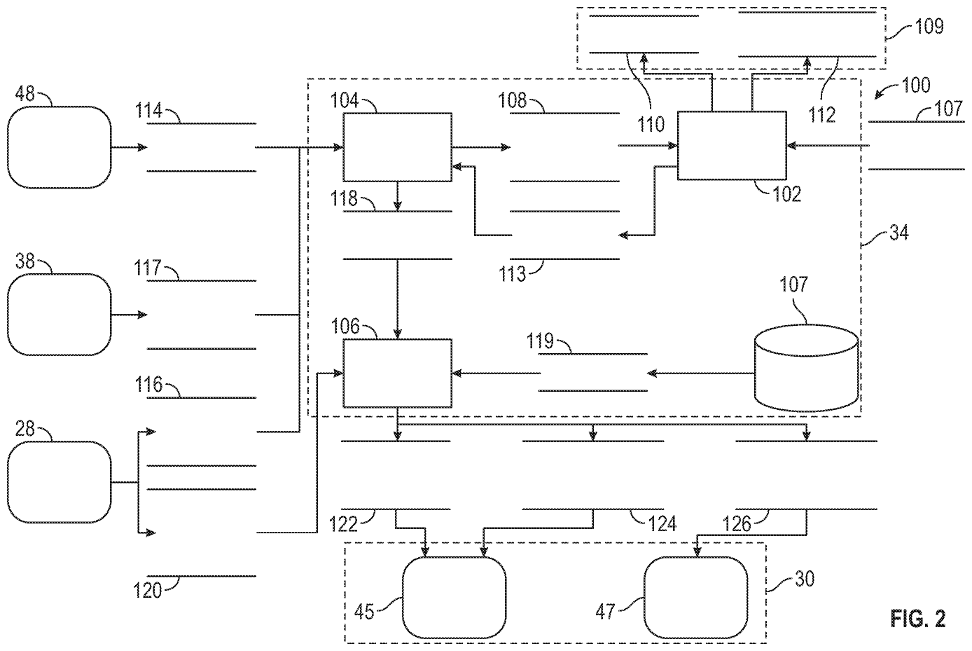

With reference now to FIG. 2 and with continued reference to FIG. 1, FIG. 2 is a dataflow diagram illustrating aspects of the intersection control system 100 in more detail. As can be appreciated, the modules and sub-modules shown in FIG. 2 can be combined and/or further partitioned to similarly perform the functions described herein. Inputs to modules and sub-modules may be received from the sensor system 28, received from other control modules (not shown) associated with the vehicle 10, received from the human-machine interface 40, received from the communication system 36, and/or determined/modeled by other sub-modules (not shown) within the controller 34 of FIG. 1. The modules and sub-modules shown generally perform the functions of determining a virtual lane through an intersection and controlling the vehicle 10 based thereon. Thus, as shown in FIG. 2, the intersection control system 100 includes a user interface (UI) control module 102, an intersection mapping module 104, an intersection control module 106 and a threshold datastore 107.

The UI control module 102 receives as input intersection notification data 108. The intersection notification data 108 includes a path of travel for the vehicle 10 through the intersection, which is received from the intersection mapping module 104. In one example, the intersection notification data 108 comprises a notification that the vehicle 10 will proceed straight, the vehicle 10 will turn right or the vehicle 10 will turn left. Based on the intersection notification data 108, the UI control module 102 generates and outputs guidance data 109. In one example, the guidance data 109 includes user interface (UI) data 110 and audio guidance data 112. The UI data 110 includes a notification for rendering on the display 42 that graphically indicates the path of travel for the vehicle 10. For example, the UI data 110 may include an arrow or other suitable graphical indicator that visually indicates the path for the vehicle 10 to assist in guiding the operator through the intersection. Based on the intersection notification data 108, the UI control module 102 also generates and outputs audio guidance data 112. The audio guidance data 112 is one or more control signals for the audible device 43 to output an audible notification of the path of travel of the vehicle 10 through the intersection. Thus, the audio guidance data 112 provides audible guidance for the operator to assist the operator in navigating or understanding the path of the vehicle 10 through the intersection. For example, the audio guidance data 112 may provide audible guidance, including, but not limited to, “Continue on the left lane,” etc.

The UI control module 102 also receives input data 107 from the human-machine interface 40. The input data 107 comprises data received from the user's interaction with the human-machine interface 40, and in one example, comprises input received to the turn signal lever 27. The UI control module 102 processes the input data 107 and sets turn signal data 113 for the intersection mapping module 104. In this example, the UI control module 102 processes the signals received from the turn signal lever 27 and determines whether the turn signal lever 27 has been moved by the user to indicate that the user plans to turn the vehicle 10 to the left or to the right. The turn signal data 113 is data that indicates whether the turn signal lever 27 indicates a left turn or whether the turn signal lever 27 indicates a right turn.

The intersection mapping module 104 receives as input intersection data 114. The intersection data 114 is map data regarding an intersection, which is received as a message broadcast from the other entities 48, such as an infrastructure associated with the intersection, via the communication system 36. In one example, the intersection data 114 includes, but is not limited to: intersection geometry; an intersection reference identifier; a reference point (latitude and longitude) for the intersection, which in one example, is a center point of the intersection; a lane width of each lane in the intersection; a list of lanes; a list of maneuvers allowed from each lane (for example, right turn, left turn, straight); at least one or a plurality of node points that define the boundaries of each of the lanes; a center point of a stop line associated with each of the lanes; and for each lane, a list of lanes that can be connected to from that particular lane and a list of allowed maneuvers into the connected lane.

The intersection mapping module 104 also receives as input vehicle position data 116. In one example, the intersection mapping module 104 receives the vehicle position data 116 from the sensor system 28. The vehicle position data 116 includes time series data from, for example, a GPS system of the sensor system 28. The vehicle position data 116 is processed by the intersection mapping module 104 to determine a GPS (latitude, longitude) of the vehicle 10. In various embodiments, the vehicle position data 116 further includes camera domain information from the sensor system 28 including a lane position for the vehicle 10. In other embodiments, the intersection mapping module 104 determines the lane position of the vehicle 10 (or the lane the vehicle 10 is in) by matching the GPS (latitude, longitude) of the vehicle 10 to the intersection geometry received in the intersection data 114. For example, the intersection mapping module 104 uses the GPS (latitude, longitude) of the vehicle 10 along with the intersection geometry received in the intersection data 114 to determine which lane the vehicle 10 is located in by comparing the current location of the vehicle 10 to the center point of the stop line associated with each of the lanes in the intersection geometry.

The intersection mapping module 104 also receives as input vehicle heading data 117. In one example, the vehicle heading data 117 is received from the navigation system 38. The vehicle heading data 117 includes a heading of the vehicle 10, which comprises a compass direction in which the vehicle 10 is pointing. In addition, the vehicle heading data 117 includes a rate of change of heading of the vehicle 10, which indicates how the heading of the vehicle 10 has changed over a pre-defined time interval. The intersection mapping module 104 also receives as input the turn signal data 113 from the UI control module 102.

Based on the lane position of the vehicle 10, the intersection mapping module 104 determines, based on the intersection data 114, a center of the lane of the vehicle 10 at the stop line of the particular lane. In one example, based on the lane position identified, the intersection mapping module 104 extracts the center point for the stop line from the intersection data 114. Based on the lane position of the vehicle 10, the intersection mapping module 104 also determines, based on the intersection data 114, a connecting or matching lane on the other side of the intersection. For example, the intersection mapping module 104 extracts the list of lanes that can be connected to from that particular lane and a list of allowed maneuvers into the connected lane from the intersection data 114. Based on at least one of the heading of the vehicle 10, the rate of change of the heading and the turn signal data 113, the intersection mapping module 104 determines a future lane of travel for the vehicle 10 or the connecting lane for the vehicle 10 on the opposite side of the intersection. In other embodiments, the intersection mapping module 104 may determine the future lane of travel of the vehicle 10 or the connecting lane based on data received from the navigation system 38, a speed profile or acceleration/deceleration received from the sensor system 28, a steering wheel angle received from the sensor system 28, etc.

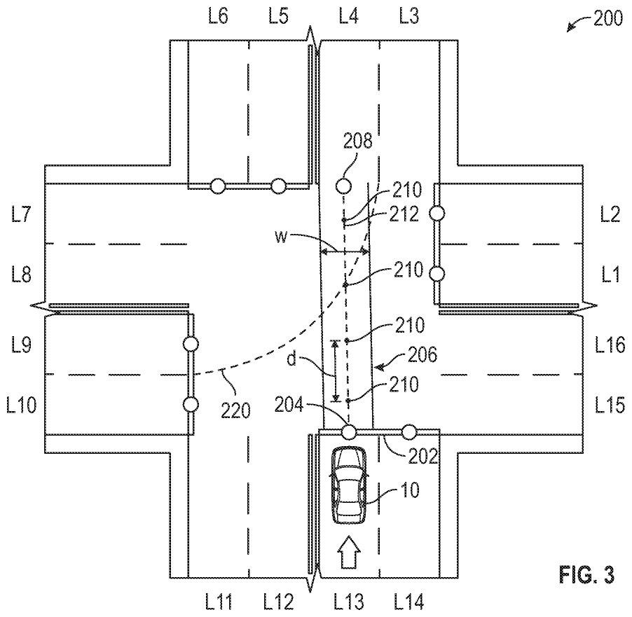

For example, with reference to FIG. 3, an exemplary intersection 200 is shown, with lanes numbered L1-L16. In the example of FIG. 3, the vehicle 10 positioned is in lane L13 and lane L13 is the current lane of travel of the vehicle 10. Lane L13 has a stop line 202, and a center point 204 is at the stop line 202. Based on the intersection data 114, the connecting lanes for lane L13 are lanes L4 and L8; and the permitted maneuvers from lane L13 are to go straight through the intersection 200 into lane L4 or to turn left into lane L8. In the example of the vehicle 10 as an autonomous vehicle, a selection of the connecting lane on the opposite side of the intersection may be based on the planned route for the travel of the vehicle 10 autonomously. In the example of a non-autonomous or semi-autonomous vehicle 10, parameters such as the turn signal data 113 and the vehicle heading and rate of change of the vehicle heading from the vehicle heading data 117 are utilized to estimate the direction of travel for the vehicle 10 through the intersection. In this example, the intersection mapping module 104 of the controller 34 determines that possible lanes of travel for the vehicle 10 through the intersection 200 are L4 or L8. Based on the heading or rate of change of the heading of the vehicle 10 from the vehicle heading data 117 indicating the vehicle 10 is orientated to go straight through the intersection, such as a change in heading less than negative 20 degrees or a change in heading less than positive 20 degrees, the intersection mapping module 104 determines the connecting lane as lane L4. Generally, a change in heading of greater than about positive 20 degrees indicates a right turn, and a change in head of greater than about negative 20 degrees indicates a left turn. In other example, based on the lack of turn signal data 113 (which indicates the turn signal lever 27 has not be moved), the intersection mapping module 104 determines the connecting lane as lane L4. In another example, based on a steering wheel angle of about 0 degrees (indicating that the steering wheel 25 (FIG. 1) has not been moved), the intersection mapping module 104 determines the connecting lane as lane L4. As a further example, based on the speed profile indicating that the vehicle 10 is not decelerating, the intersection mapping module 104 determines the connecting lane as lane L4. In another example, based on the yaw rate of about 0 degrees (indicating that the vehicle 10 is not turning), the intersection mapping module 104 determines the connecting lane as lane L4. It should be noted that the intersection mapping module 104 may use one or more of the turn signal data 113, the vehicle heading and rate of change of the vehicle heading, the steering wheel angle, the speed profile and the yaw rate to determine a connecting lane for the vehicle 10.

Based on the determination of the connecting lane for the vehicle 10 on the other side or across the intersection 200 as lane L4, the intersection mapping module 104 of the controller 34 determines a possible virtual lane 206 for the vehicle 10 through the intersection 200. In addition, based on the determination of the connecting lane for the vehicle 10 through the intersection, with reference back to FIG. 2, the intersection mapping module 104 sets the intersection notification data 108 for the UI control module 102.

In one example, the intersection mapping module 104 determines the virtual lane based on the coordinate locations (latitude and longitude) of two connecting points on each side of the intersection. In the example of FIG. 3, the center point 204 is a first connecting point and a center point 208 of lane L4 is a second connecting point. The coordinate location of the center point 208 is extracted from the intersection data 114. The intersection mapping module 104 calculates the distance between the coordinate location of the first connecting point (center point 204 in the example of FIG. 3) and the second connecting point (center point 208 in the example of FIG. 3). In one example, the intersection mapping module 104 calculates the distance between the two connecting points using the great circle method, however other techniques may be used. In this example, the intersection mapping module 104 calculates the distance between the first connecting point and the second connecting point based on the following:

$$a = ( sin \frac{{Delta}_{Lat}}{2} ) + cos ( {Lat}_{1} ) * cos ( {Lat}_{2} ) * {( sin ( \frac{{Delta}_{Long}}{2} ) )}^{2} \qquad ( 1 )$$

Wherein a is the square of half the chord length between the two connecting points; and Delta_{Lat} is defined by the following equation:

Delta_{Lat}=Lat₂−Lat₁ (2)

Wherein Lat₁ is the latitude of the first connecting point (center point 204 in the example of FIG. 3); and Lat₂ is the latitude of the second connecting point (center point 208 in the example of FIG. 3). In equation (1), Delta_{Long} is defined by the following equation:

Delta_{Long}=Long₂−Long₁ (3)

Wherein Long₁ is the longitude of the first connecting point (center point 204 in the example of FIG. 3); and Long₂ is the longitude of the second connecting point (center point 208 in the example of FIG. 3).

Based on a from equation (1), the intersection mapping module 104 determines the angular distance between the two connecting points based on the following equation:

$$c = 2 * {tan}^{- 1} ( \frac{\sqrt{a}}{\sqrt{( 1 - a )}} ) \qquad ( 4 )$$

Wherein c is the angular distance between the two connecting points in radians. Based on c, the intersection mapping module 104 calculates the distance between the two connecting points with the following equation:

D=R*c (5)

Wherein D is the distance between the two connecting points in meters; R is the radius of the earth, which is 6,371,000 meters; and c is determined from equation (4).

The intersection mapping module 104 estimates the number of intermediate points between the two sides of the intersection based on the following equation:

$$n = Integer of ( \frac{D}{d} - 1 ) \qquad ( 6 )$$

Wherein D is the distance between the two connecting points from equation (5); d is a predefined distance between the intermediate points in meters, and in one example is about 1.0 meter; and n is the number of intermediate points.

The intersection mapping module 104 calculates an initial bearing between the coordinate locations (latitude and longitude) of the two connecting points (center points 204, 208 in the example of FIG. 3). In one example, the intersection mapping module 104 calculates the initial bearing based on the following:

$$\begin{matrix} y = sin ( {Long}_{2} - {Long}_{1} ) * cos ( {Lat}_{2} ) & ( 7 ) \\ x = cos ( {Lat}_{1} ) * sin ( {Lat}_{2} ) - sin ( {Lat}_{1} ) * cos ( {Lat}_{2} ) * cos ( {Long}_{2} - {Long}_{1} ) & ( 8 ) \\ Bearing = {tan}^{- 1} ( \frac{y}{x} ) & ( 9 )\end{matrix}$$

Wherein Lat₁ is the latitude of the first connecting point (center point 204 in the example of FIG. 3); Lat₂ is the latitude of the second connecting point (center point 208 in the example of FIG. 3); Long₁ is the longitude of the first connecting point (center point 204 in the example of FIG. 3); Long₂ is the longitude of the second connecting point (center point 208 in the example of FIG. 3); and Bearing is the initial bearing between the two coordinate locations in radians.

The intersection mapping module 104 calculates a coordinate location for each of the n number of intermediate points at each predefined distance d between the two connecting points. In one example, the intersection mapping module 104 calculates the coordinate location for each of the n number of intermediate points in a loop from i=1 to (n+1) at the distance d based on the following:

$$\begin{matrix} {d}_{i} = d * i & ( 10 ) \\ {Lat}_{i} = {sin}^{- 1} ( sin ( {Lat}_{1} ) * cos ( \frac{{d}_{i}}{R} ) + cos ( {Lat}_{1} ) * sin ( \frac{{d}_{i}}{R} ) * cos ( Bearing ) ) & ( 11 ) \\ {Long}_{i} = {Long}_{i} + {tan}^{- 1} ( \frac{sin ( \frac{{d}_{i}}{R} ) * sin ( Bearing ) * cos ( {Lat}_{1} )}{cos ( \frac{{d}_{i}}{R} ) - sin ( {Lat}_{1} ) * sin ( {Lat}_{i} )} ) * cos ( Bearing ) & ( 12 )\end{matrix}$$

Wherein d is the predefined distance in meters; Lat₁ is the latitude of the first connecting point (center point 204 in the example of FIG. 3); R is the radius of the earth, which is 6,371,000 meters; Bearing is the initial bearing between the two coordinate locations in radians; Latᵢ is the latitude of intermediate point i; and Longᵢ is the longitude of the intermediate point i.

The intersection mapping module 104 extrapolates the virtual lane through the intersection based on the coordinate location of the first connecting point, the coordinate location of the second connecting point and the coordinate location of each of the intermediate points between the first connecting point and the second connecting point. In this example, the intersection mapping module 104 extrapolates the virtual lane as a line or arc that interconnects the first connecting point, the second connecting point and the intermediate points, and based on a width of the lanes from the intersection data 114, the intersection mapping module 104 may define the width of the virtual lane. For example, the intersection mapping module 104 may define the width of the virtual lane as the same as the width of the lanes from the intersection data 114. In this example, the intersection mapping module 104 may define the virtual lane by dividing the width of the lanes from the intersection data 114 in half, and adding half the width to either side of the line or arc that defines the virtual lane to determine a full width of the virtual lane for the travel of the vehicle 10. In other embodiments, the width of the virtual lane may be a pre-defined threshold value that is retrieved from the media 46 and used to define the full width of the virtual lane for the travel of the vehicle 10 based on the line or arc that defines the virtual lane and the pre-defined threshold value. In this example, the pre-defined threshold may be about 3.22 meters (m) for an intersection in a city, for example. Based on the line or arc determined by extrapolating the coordinate location of the first connecting point, the coordinate location of the second connecting point and the coordinate location of each of the intermediate points between the first connecting point and the second connecting point, the intersection mapping module 104 adds about 1.61 meters (m) to a first, left side of the line or arc, and adds about 1.6.1 meters (m) to a second, right side of the line or arc, to define the virtual lane with a full lane width of about 3.22 meters (m) through the intersection. The intersection mapping module 104 sets the determined virtual lane as virtual lane data 118 for the intersection control module 106. The virtual lane data 118 comprises the coordinate locations of the virtual lane, as determined through the extrapolation of the coordinate location of the first connecting point, the coordinate location of the second connecting point and the coordinate location of each of the intermediate points between the first connecting point and the second connecting point, along with the full width of the virtual lane.

With reference to FIG. 3, the virtual lane 206 is defined by intermediate points 210 defined at the distance d between the first connecting point (center point 204) and the second connecting point (center point 208). The width of the virtual lane 206 is defined based on the width of the lanes L1-16 of the intersection 200, and in this example, a width W of the virtual lane 206 is defined by adding half of the width of the lanes of the intersection 200 to either side of a line 212 that is defined by the intermediate points 210, the first connecting point (center point 204) and the second connecting point (center point 208).

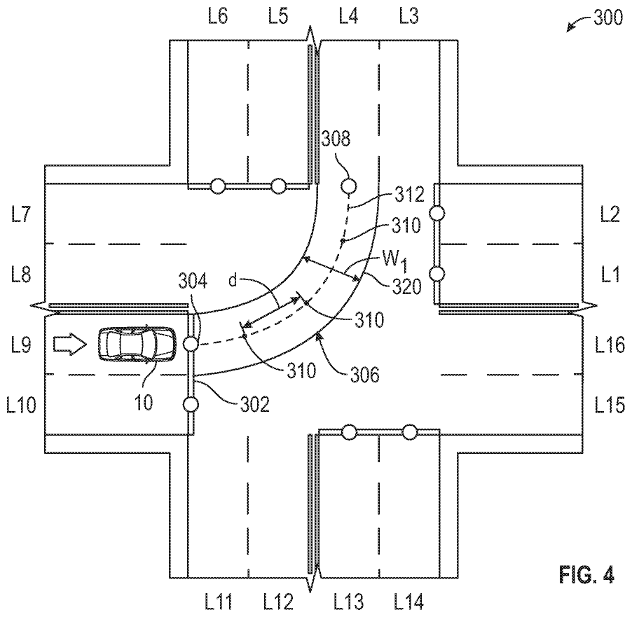

With reference to FIG. 4, another example of a virtual lane 306 through an intersection 300 determined by the intersection mapping module 104 of the controller 34 is shown. The intersection 300 includes lanes numbered L1-L16. In the example of FIG. 4, the vehicle 10 is positioned in lane L9 and lane L9 is the current lane of travel for the vehicle 10. Lane L9 has a stop line 302, and a center point 304 is at the stop line 302. Based on the intersection data 114, the connecting lanes for lane L9 are lanes L4 and L16; and the permitted maneuvers from lane L9 are to go straight through the intersection 300 into lane L16 or to turn left into lane L4. In this example, the vehicle 10 is about to make a left turn into L4. In example of the vehicle 10 as an autonomous vehicle, a virtual lane selection is performed based on the planned route for the autonomous vehicle. In the example of a non-autonomous or semi-autonomous vehicle 10, at least one parameter such as the turn signal data 113 and the vehicle heading and rate of change of the vehicle heading from the vehicle heading data 117 are utilized to estimate the direction of travel. For example, the intersection mapping module 104 of the controller 34 determines that the possible lane of travel or the connecting lane for the vehicle 10 on the opposite side of the intersection 200 is lane L4 based on the turn signal data 113 indicating a left turn, the vehicle heading and/or rate of change of the vehicle heading from the vehicle heading data 117 indicating a turn maneuver. For example, if the vehicle heading has changed by about negative 20 degrees, the intersection mapping module 104 determines that the vehicle 10 is making a left turn and that the connecting lane for the vehicle 10 is lane L4. If, however, the heading and rate of change of heading of the vehicle 10 from the vehicle heading data 117 indicates a straight maneuver (a change in heading less than about 20 degrees) and/or there is lack of turn signal data 113 (which indicates that the turn signal lever 27 has not been moved), the intersection mapping module 104 of the controller 34 determines that the connecting lane for the vehicle 10 is lane L16. In another example, based on a steering wheel angle of greater than negative 10 degrees (indicating that the steering wheel 25 (FIG. 1) has been moved toward the left), the intersection mapping module 104 determines the connecting lane as lane L4. As a further example, based on the speed profile indicating that the vehicle 10 is decelerating, the intersection mapping module 104 determines the connecting lane as lane L4. In another example, based on the yaw rate of about negative 10 degrees (indicating that the vehicle 10 is turning left), the intersection mapping module 104 determines the connecting lane as lane L4. It should be noted that the intersection mapping module 104 may use one or more of the turn signal data 113, the vehicle heading and rate of change of the vehicle heading, the steering wheel angle, the speed profile and the yaw rate to determine a connecting lane for the vehicle 10.

Based on the determination of the connecting lane for the vehicle 10 on the other side or across the intersection 300 as lane L4, the intersection mapping module 104 of the controller 34 determines the virtual lane 306 for the vehicle 10 through the intersection 300. The lane L4 has a center point 308. The virtual lane 306 is defined by intermediate points 310 defined at the distance d between the first connecting point (center point 304) and the second connecting point (center point 308). The width of the virtual lane 306 is defined based on the width of the lanes L1-16 of the intersection 300, and in this example, a width W1 of the virtual lane 306 is defined by adding half of the width of the lanes of the intersection 300 to either side of a line 312 that is defined by the intermediate points 310, the first connecting point (center point 304) and the second connecting point (center point 308).

With reference back to FIG. 2, the threshold datastore 107 stores one or more thresholds associated with a difference between a lane marking detected by the sensor system 28 and the virtual lane data 118. For example, the threshold datastore 107 stores at least a threshold 119 for an amount of variation between the lane marking detected by the sensor system 28 and the virtual lane data 118. The threshold 119 stored in the threshold datastore 107 is a predefined, and factory set value. In one example, the threshold 119 is an acceptable percent difference between the lane marking detected by the sensor system 28 and the virtual lane data 118. In this example, the threshold 119 is about 10%.

The intersection control module 106 receives as input the virtual lane data 118 from the intersection mapping module 104. The intersection control module 106 also receives as input lane marking detection data 120. The lane marking detection data 120 is data regarding lane markings that are identified based on image data from the optical cameras associated with the sensor system 28, for example. Generally, the lane marking detection data 120 comprises data regarding observed or detected lane markings, including, but not limited to, a geometry of dashed lines, solid lines, etc. that are identified in an image data stream from one or more of the optical cameras of the sensor system 28. The intersection control module 106 compares the virtual lane data 118 to the lane marking detection data 120 and determines whether the virtual lane determined by the intersection mapping module 104 corresponds with the lane marking detected in the lane marking detection data 120. The intersection control module 106 queries the threshold datastore 107 and retrieves the threshold 119. Based on the retrieved threshold, the intersection control module 106 determines whether a geometry of the lane marking detected corresponds with or matches the geometry of the virtual lane within the threshold 119. For example, the intersection control module 106 may perform pattern matching to determine whether a pattern of the lane marking matches a pattern of the virtual lane within the threshold 119. In another example, the intersection control module 106 may perform curve fitting to determine whether the geometry of the lane marking from the lane marking detection data 120 matches the geometry of the virtual lane within the threshold 119.

If the lane marking detected by the sensor system 28 corresponds with or matches the virtual lane determined by the intersection mapping module 104 within the threshold 119, the intersection control module 106 generates and outputs lateral control data 122. The lateral control data 122 is one or more control signals to the actuator system 30, such as to the lateral control system 45, to control the vehicle 10 through the intersection based on the virtual lane.

For example, with reference to FIG. 4, an optical camera of the sensor system 28 detects a lane marking 320. In this example, the lane marking 320 is a curved dashed line for a turn from lane L9 to lane L4. The intersection control module 106 of the controller 34 compares the lane marking 320 detected to the virtual lane 306. As the lane marking 320 corresponds with the virtual lane 306 within the threshold 119 (within about 10%), the intersection control module 106 generates and outputs the lateral control data 122 (FIG. 2) to control the vehicle 10 by the lateral control system 45 (FIG. 1) through the intersection 300 based on the virtual lane 306.

With reference back to FIG. 2, if the lane marking detected by the sensor system 28 does not correspond with or conflicts with the virtual lane determined by the intersection mapping module 104 by a difference greater than or outside of the threshold 119, the intersection control module 106 generates and outputs lateral control suppression data 124. The lateral control suppression data 124 is one or more control signals to the actuator system 30, such as to the lateral control system 45, to suppress the control of the vehicle 10 through the intersection. Stated another way, the lateral control suppression data 124 is one or more control signals to disable the lateral control system 45 associated with the actuator system 30 such that the vehicle 10 is not controlled laterally through the intersection. This ensures that the vehicle 10 is not controlled based on the lane marking detected by the optical camera of the sensor system 28, which ensures that the vehicle 10 is not controlled based on inapplicable lane markings detected in the intersection.

For example, with reference to FIG. 3, the camera of the sensor system 28 detects a lane marking 220. In this example, the lane marking 220 is a curved dashed line for a turn from lane L9 to lane L4. The intersection control module 106 of the controller 34 compares the lane marking 220 detected to the virtual lane 206. In this example, the lane marking 220 does not correspond with or match the geometry of the virtual lane 206 within the threshold 119 (greater than about 10% difference in geometry) or conflicts with the virtual lane 206. The intersection control module 106 generates and outputs the lateral control suppression data 124 (FIG. 2), which suppresses the control of the vehicle 10 by the lateral control system 45 (FIG. 1) through the intersection 200. This ensures that the vehicle 10 does not inadvertently follow the lane marking 220 detected by the sensor system 28.

With reference back to FIG. 2, in various embodiments, based on the virtual lane data 118, the intersection control module 106 may also generate and output lane centering data 126. The lane centering data 126 is one or more control signals to the lane centering system 47 of the actuator system 30 to control the vehicle 10 based on the virtual lane. In this regard, the lane centering system 47 of the actuator system 30 may control the vehicle 10 to maintain the vehicle 10 as centered within the virtual lane as the vehicle 10 travels through the intersection. In addition, in certain embodiments, in the example of a vehicle 10 that includes an active safety seat or a driver's seat with haptic feedback, the driver's seat may be controlled, by the controller 34, to output haptic feedback based on the position of the vehicle 10 relative to the virtual lane data 118. For example, as the vehicle 10 traverses the virtual lane, if the vehicle 10 crosses a right side boundary of the virtual lane, the controller 34 outputs one or more control signals to the haptic seat to provide haptic feedback on a right side of the seat that indicates that the vehicle 10 has crossed the right side boundary of the virtual lane. As a further example, as the vehicle 10 traverses the virtual lane, if the vehicle 10 crosses a left side boundary of the virtual lane, the controller 34 outputs one or more control signals to the haptic seat to provide haptic feedback on a left side of the seat that indicates that the vehicle 10 has crossed the left side boundary of the virtual lane.

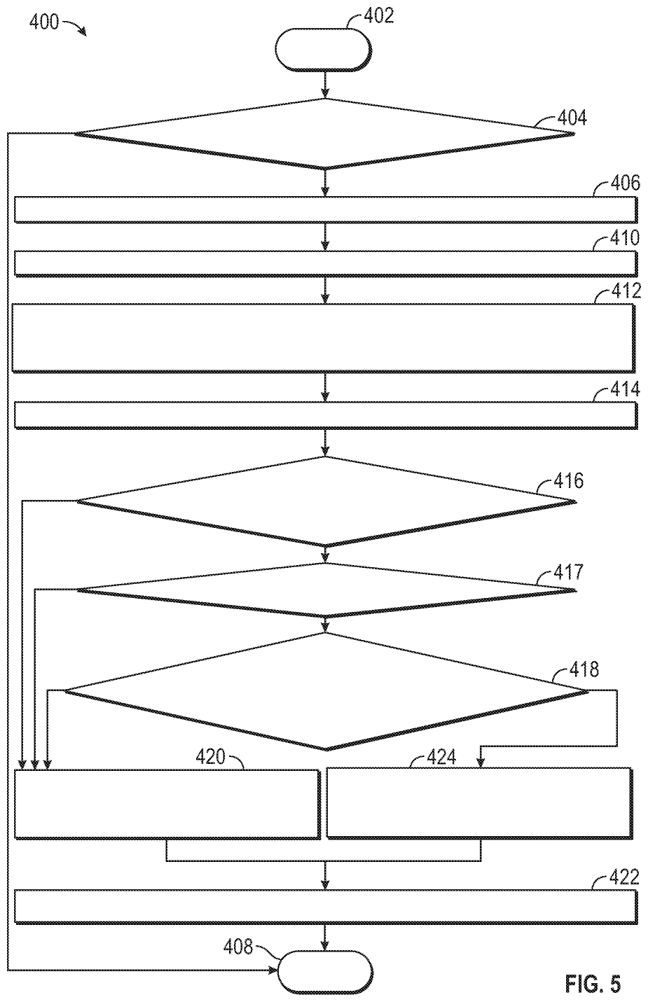

With reference now to FIG. 5, and continued reference to FIGS. 1 and 2, a flowchart illustrates a control method 400 that may be performed by the intersection control system 100 in accordance with various embodiments. In various embodiments, the control method 400 is performed by the processor 44 of the controller 34. As can be appreciated in light of the disclosure, the order of operation within the method is not limited to the sequential execution as illustrated in FIG. 5 but may be performed in one or more varying orders as applicable and in accordance with the present disclosure. In various embodiments, the control method 400 can be scheduled to run based on one or more predetermined events, and/or can run continuously during operation of the vehicle 10.

The method begins at 402. At 404, the method determines whether the intersection data 114 has been received from the other entities 48, such as from infrastructure associated with an intersection. If true, the method proceeds to 406. Otherwise, the method ends at 408.

At 406, the method extracts the intersection data 114 from the intersection message that is received from the other entities 48 by the communication system 36. At 410, the method determines the current lane of travel of the vehicle 10 based on the position of the vehicle 10 (received from the sensor system 28) and the intersection data 114. The method also determines a center of the current lane of the vehicle 10 at the stop line associated with the current lane of travel based on the intersection data 114.

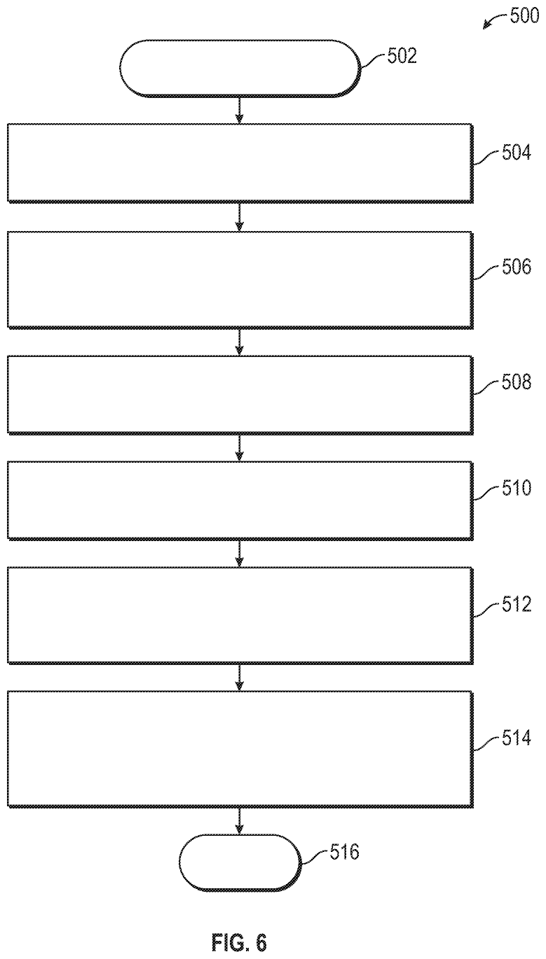

At 412, the method determines the connecting lane at the other side of the intersection based on at least one of the vehicle heading, the rate of change of the vehicle heading (received from the navigation system 38) and turn signal data, and the current lane of travel of the vehicle. At 414, the method determines the virtual lane through the intersection, using the method discussed with regard to FIG. 6, below.

At 416, the method determines whether lane marking detection data 120 is received from the sensor system 28. If true, the method proceeds to 417. If false, the method proceeds to 420. At 417, the method determines whether a lane marking has been identified by the camera of the sensor system 28. If true, the method proceeds to 418. Otherwise, the method proceeds to 420. At 420, the method outputs one or more control signals to the lateral control system 45 of the actuator system 30 to control the vehicle 10 through the intersection based on the virtual lane (i.e. outputs the lateral control data 122). At 422, the method outputs the guidance data 109 and optionally, outputs one or more control signals to the lane centering system 47 of the actuator system 30 to control the vehicle 10 through the intersection based on the virtual lane (i.e. outputs the lane centering data 126). Optionally, the method may output one or more control signals to the haptic seat to provide haptic feedback to the user based on the virtual lane. The method ends at 408.

If, at 417, the lane marking detection data 120 is received that indicates that a lane marking has been identified by the sensor system 28, the method at 418 determines whether the geometry of the virtual lane corresponds with or matches the lane marking provided by the sensor system 28 within the threshold 119 retrieved from the threshold datastore 107 (FIG. 2). If true, the method proceeds to 420. Otherwise, if false, the method, at 424 outputs one or more control signals to the lateral control system 45 of the actuator system 30 to suppress the lateral control system 45 such that the vehicle 10 is not laterally controlled through the intersection (i.e. outputs the lateral control suppression data 124). The method proceeds to 422.

With reference to FIG. 6, and continued reference to FIGS. 1 and 2, a flowchart illustrates a method 500 to determine the virtual lane that may be performed by the intersection control system 100 in accordance with various embodiments. In various embodiments, the method 500 is performed by the processor 44 of the controller 34. As can be appreciated in light of the disclosure, the order of operation within the method is not limited to the sequential execution as illustrated in FIG. 6 but may be performed in one or more varying orders as applicable and in accordance with the present disclosure.

The method to determine the virtual lane begins at 502. At 504, the method determines the coordinate locations of the two connecting points on each side of the intersection based on the intersection data 114, the current lane of travel and the future lane of travel or connecting lane. At 506, the method calculates the distance between the two coordinate locations of the two connecting points using the equations (1)-(5). At 508, the method estimates the number of intermediate points between each side of the intersection using the equation (6). At 510, the method calculates the initial bearing between the coordinate locations of the two connecting points using the equations (7)-(9). At 512, the method calculates the coordinate location of at least one intermediate point at the distance d given the coordinate location of the first connecting point and the bearing using the equations (10)-(12). At 514, the method extrapolates the virtual lane based on the coordinate location of the first connecting point, the coordinate location of the second connecting point and the coordinate location of the at least one intermediate point. The method ends at 516.

It should be noted that while the example provided herein determined the virtual based on the equations (1)-(12), in other embodiments, the virtual lane may be determined by the controller 34 based on the equations (1)-(12) as well as image data or other sensor data received from the sensor system 28. Moreover, in other embodiments, the virtual lane may be determined by the controller 34 based on the equations (1)-(12) as well as vehicle to vehicle communications received from the communication system 36 and/or open street map data received from the communication system 36, etc.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for controlling a lateral position of a vehicle through an intersection, comprising:
receiving, by a processor, intersection data transmitted by an infrastructure associated with the intersection, the intersection data including at least a position of a plurality of lanes associated with the intersection;
receiving, by the processor, a position of the vehicle;
determining, by the processor, a current lane of travel of the vehicle and a future lane of travel of the vehicle based on the intersection data and the position of the vehicle, the current lane of travel spaced apart from the future lane of travel by the intersection;
determining, by the processor, a virtual lane through the intersection, the virtual lane providing a path of travel for the vehicle from the current lane of travel to the future lane of travel; and
controlling, by the processor, the vehicle based on the virtual lane.

2. The method of claim 1, wherein the controlling, by the processor, the vehicle based on the virtual lane further comprises:
outputting, by the processor, one or more control signals to a lateral control system of the vehicle to maintain the vehicle within the virtual lane.

3. The method of claim 1, wherein the controlling, by the processor, the vehicle based on the virtual lane further comprises:
outputting, by the processor, one or more control signals to a human-machine interface to guide an operator of the vehicle through the intersection.

4. The method of claim 1, further comprising:
receiving, by the processor, a lane marking associated with the intersection identified by at least one camera associated with the vehicle;
determining, by the processor, whether the lane marking associated with the intersection corresponds with the virtual lane; and
controlling, by the processor, the vehicle based on the determining whether the lane marking associated with the intersection corresponds with the virtual lane.

5. The method of claim 4, wherein the controlling, by the processor, the vehicle based on the determining whether the lane marking associated with the intersection corresponds with the virtual lane further comprises:
determining, by the processor, the lane marking associated with the intersection corresponds with the virtual lane; and
outputting, by the processor, one or more control signals to a lateral control system to maintain the vehicle within the virtual lane.

6. The method of claim 4, wherein the controlling, by the processor, the vehicle based on the determining whether the lane marking associated with the intersection corresponds with the virtual lane further comprises:
determining, by the processor, the lane marking associated with the intersection conflicts with the virtual lane; and
outputting, by the processor, one or more control signals to a lateral control system to suppress lateral control based on the determining that the lane marking associated with the intersection conflicts with the virtual lane.

7. The method of claim 1, wherein the determining, by the processor, the current lane of travel of the vehicle and the future lane of travel of the vehicle further comprises:
determining, by the processor, the current lane of the vehicle based on the position of the vehicle and the intersection data;
receiving, by the processor, at least one of a heading of the vehicle, a rate of change of the heading of the vehicle and turn signal data associated with a turn signal lever of the vehicle; and
determining, by the processor, the future lane of travel based on the at least one of the heading, the rate of change of the heading and the turn signal data, the current lane of travel and the intersection data.

8. The method of claim 1, wherein the determining, by the processor, the virtual lane through the intersection further comprises:
determining, by the processor, a coordinate location of a first point on the current lane and a coordinate location of a second point on the future lane;
calculating, by the processor, a distance between the coordinate location of the first point and the coordinate location of the second point;
determining, by the processor, at least one intermediate point between the current lane and the future lane based on the distance;
calculating, by the processor, a coordinate location for the at least one intermediate point based on the coordinate location of the first point or the second point and the distance; and
extrapolating, by the processor, the virtual lane based on the coordinate location for the first point, the coordinate location for the second point and the coordinate location of the at least one intermediate point.

9. A system for controlling a lateral position of a vehicle through an intersection with a lateral control system, comprising:
a communication system having a receiver configured to receive intersection data including at least a position of a plurality of lanes associated with the intersection;
a sensor system that provides a position of the vehicle and a lane marking associated with the intersection that is detected by a camera of the vehicle;
a controller having a processor programmed to:
determine a current lane of travel of the vehicle and a future lane of travel of the vehicle based on the intersection data and the position of the vehicle, the current lane of travel spaced apart from the future lane of travel by the intersection;
determine a virtual lane through the intersection, the virtual lane providing a path of travel for the vehicle from the current lane of travel to the future lane of travel;
compare the virtual lane to the lane marking; and
output one or more control signals to the lateral control system based on the comparison.

10. The system of claim 9, wherein the processor is programmed to output one or more control signals to a human-machine interface to guide an operator of the vehicle through the intersection.

11. The system of claim 9, wherein based on the comparison of the virtual lane to the lane marking, the processor is further programmed to output one or more control signals to the lateral control system to maintain the vehicle within the virtual lane based on the virtual lane corresponding with the lane marking.

12. The system of claim 9, wherein based on the comparison of the virtual lane to the lane marking, the processor is further programmed to output one or more control signals to the lateral control system to suppress lateral control based on the virtual lane conflicting with the lane marking.

13. The system of claim 9, wherein the processor is further programmed to determine the current lane of the vehicle based on the position of the vehicle and the intersection data, to receive at least one of a heading of the vehicle, a rate of change of the heading of the vehicle and turn signal data associated with a turn signal lever of the vehicle, and to determine the future lane of travel based on the at least one of the heading, the rate of change of the heading and the turn signal data, the current lane of travel and the intersection data.

14. The system of claim 9, wherein the processor is further programmed to determine a coordinate location of a first point on the current lane and a coordinate location of a second point on the future lane, to calculate a distance between the coordinate location of the first point and the coordinate location of the second point, to determine at least one intermediate point between the current lane and the future lane based on the distance, to calculate a coordinate location for the at least one intermediate point based on the coordinate location of the first point or the second point and the distance, and to extrapolate the virtual lane based on the coordinate location for the first point, the coordinate location for the second point and the coordinate location of the at least one intermediate point.

15. The system of claim 9, wherein the processor is further programmed to output one or more control signals to a lateral centering system associated with the vehicle based on the virtual lane.

16. A vehicle, comprising:
a communication system onboard the vehicle having a receiver configured to receive intersection data including at least a position of a plurality of lanes associated with the intersection;
a sensor system onboard the vehicle that provides a position of the vehicle and a lane marking associated with the intersection that is detected by a camera of the vehicle;
an actuator system onboard the vehicle including a lateral control system that is configured to control a lateral position of the vehicle;
a controller having a processor programmed to:
determine a current lane of travel of the vehicle and a future lane of travel of the vehicle based on the intersection data and the position of the vehicle, the current lane of travel spaced apart from the future lane of travel by the intersection;
determine a virtual lane through the intersection, the virtual lane providing a path of travel for the vehicle from the current lane of travel to the future lane of travel;
compare the virtual lane to the lane marking;
output one or more control signals to the lateral control system of the vehicle to maintain the vehicle within the virtual lane based on the virtual lane corresponding with the lane marking; and
output one or more control signals to the lateral control system to suppress lateral control based on the virtual lane conflicting with the lane marking.

17. The vehicle of claim 16, wherein the processor is further programmed to determine the current lane of the vehicle based on the position of the vehicle and the intersection data, to receive at least one of a heading of the vehicle, a rate of change of the heading and turn signal data associated with a turn signal lever of the vehicle, and to determine the future lane of travel based on the at least one of the heading, the rate of change of the heading and the turn signal data, the current lane of travel and the intersection data.

18. The vehicle of claim 16, wherein the processor is further programmed to determine a coordinate location of a first point on the current lane and a coordinate location of a second point on the future lane, to calculate a distance between the coordinate location of the first point and the coordinate location of the second point, to determine at least one intermediate point between the current lane and the future lane based on the distance, to calculate a coordinate location for the at least one intermediate point based on the coordinate location of the first point or the second point and the distance, and to extrapolate the virtual lane based on the coordinate location for the first point, the coordinate location for the second point and the coordinate location of the at least one intermediate point.

19. The vehicle of claim 16, wherein the processor is further programmed to output one or more control signals to a lateral centering system associated with the vehicle based on the virtual lane.

20. The vehicle of claim 16, wherein the processor is programmed to output one or more control signals to a human-machine interface to guide an operator of the vehicle through the intersection.
